(19) United States
(12) Patent Application Publication
(10) Pub. No.: US 2003/0021254 A1
(43) Pub. Date: Jan. 30, 2003

(54) Wireless LAN terminal, wireless LAN base station, and wireless LAN system including them and wireless hand-off method

(75) Inventor: Yosuke Fukuda, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/197,600

(22) Filed: Jul. 18, 2002

(30) Foreign Application Priority Data
Jul. 25, 2001 (JP) 2001-224270

(51) Int. Cl. H04Q 7/00

(52) U.S. Cl. 370/338; 370/328; 370/400

(57) ABSTRACT

When a wireless LAN terminal moves to outside the cell of a first wireless LAN base station and it has entered a cell overlap area between a second wireless LAN base station cell and a third wireless LAN base station cell, it receives from the second and the third wireless base station, respectively, the network address of a network to which the second wireless LAN base station is allocated and the network address of a network to which the third wireless LAN base station is allocated. The wireless LAN terminal starts to perform a communication with the second wireless LAN base station that has transmitted on with respect thereto the same network address as that network address of the network, having the first wireless LAN base station kept in connection therewith, that that terminal holds therein.

### BACKGROUND OF THE INVENTION

1. Field of the Invention

The present invention relates to a wireless LAN (Local Area Network) technology and, more particularly, to an autonomic wireless LAN base station selecting apparatus and method for a wireless LAN terminal.

2. Description of the Related Art

In recent years, there has been put to practical use a wireless LAN system wherein a mobile terminal makes a communication with a wireless LAN base station via a wireless line and this mobile terminal is freely moved from one place to another. The wireless LAN is placed under examination in IEEE802.11 (IEEE: The US Association of Electric and Electronic Technicians) while in Japan by, for example, a report submitted from the Electric Communication Technology Council Wireless LAN Commission the allotment of electric waves (2.4 GHz-band, 1.9 GHz-band) is approved and the conversion of the technology into products has been being performed. For example, as to the physical layer of 2.4 GHz-band, there have been adopted a spectrum diffusion type of direct diffusion method (SS-DS) and a frequency hopping method (SS-FH).

In the wireless LAN system, the following is demanded.

(a) The system has means that enables the terminal to be promptly connected to a wireless LAN base station; and

(b) The amount of time during which the communication is interrupted as a result of the movement of the terminal is shortened.

In order to meet these demands, for example, in Japanese Patent No. 2963424, there is proposed a method wherein a wireless terminal having previously stored therein a domain ID of the home network selects, when wireless LAN base stations each having the same domain ID as that of the home network exist among a plurality of the ones satisfying the quality requirements for wireless communications, the one having the same domain ID as that of the home network and the most excellent quality of all. In this conventional method, the wireless terminal receives a control signal (informative signal) from neighboring wireless LAN base stations during a certain period of time and, for example, creates a list of wireless LAN base stations satisfying the quality requirements. When home wireless LAN base stations exist in the list of wireless LAN base stations, the wireless terminal selects the best quality home wireless LAN base station. When no such home wireless LAN base stations exist, the wireless terminal finds the best quality wireless LAN base station from among remote wireless base stations.

However, in this official gazette of Japanese Patent No. 2963424, the terminal is only kept storing therein the domain ID of the home network, and no description is made of means for executing updating the information of the allocation wireless LAN base station within the wireless cell of which the terminal is located, in such a manner as it moves. Nor is there described any specific construction for realizing that updating.

### SUMMARY OF THE INVENTION

Accordingly, an object of the present invention is to provide a wireless LAN system, wireless LAN method, wireless LAN apparatus, and wireless LAN program which, when a wireless LAN terminal kept in communication with a wireless LAN base station moves from one wireless cell to another and has come into a state of its being able to communicate with a plurality of wireless LAN base stations, enable the terminal to automatically select the wireless LAN base station connected to the same network as before and to continue to make its communication therewith.

According to a first aspect of the present invention, there is provided a wireless LAN terminal comprising: storage means that stores a network address to which a fist wireless LAN base station kept in wireless connection with the terminal itself is allocated; means that, when the terminal has moved to outside a cell of the first wireless LAN base station, sequentially changes the channel for a carrier; means that, when the terminal receives a beacon from a new wireless LAN base station via a new channel, transmits a synchronization request signal to the new wireless LAN base station; means that receives a synchronization confirmation signal containing therein a network address, which is sent on from the new wireless base station in response to the synchronization request signal; means that compares the network address contained in the synchronization confirmation signal with the network address stored in the storage means; and means that, when the network address contained in the synchronization confirmation signal coincides with the network address stored in the storage means, transmits an allocation request signal containing therein a media access control address of the wireless LAN terminal to the new wireless LAN base station, and, when the network address contained in the synchronization confirmation signal does not coincide with the network address stored in the storage means, does not transmit an allocation request signal to the new wireless LAN base station.

According to a second aspect of the present invention, there is provided a wireless LAN base station comprising: means that transmits a beacon; means that, when the base station receives a synchronization request signal from a wireless LAN terminal having received the beacon, transmits to the wireless LAN terminal a synchronization confirmation signal containing therein the network address to which the wireless LAN base station is allocated; means that, when the base station receives that allocation request signal containing therein a media access control of the wireless LAN terminal which has been transmitted on from the wireless LAN terminal as a response to the synchronization confirmation signal, registers the media access control with that base station itself; and means that, when the base station receives the allocation request signal, transmits an allocation approval signal to the wireless LAN terminal.

According to a third aspect of the present invention, there is provided a wireless LAN system, the wireless LAN system including a wireless LAN terminal and a plurality of wireless LAN base stations, the wireless LAN terminal comprising: storage means that stores a network address to which a fist wireless LAN base station kept in wireless connection with the terminal itself is allocated; means that, when the terminal has moved to outside a cell of the first wireless LAN base station, sequentially changes the channel for a carrier; means that, when the terminal receives a beacon from a new wireless LAN base station via a new channel, transmits a synchronization request signal to the new wireless LAN base station; means that receives a synchronization confirmation signal containing therein a network address, which is transmitted on from the new wireless base station in response to the synchronization request signal; means that compares the network address contained in the synchronization confirmation signal with the network address stored in the storage means; and means that, when the network address contained in the synchronization confirmation signal coincides with the network address stored in the storage means, transmits an allocation request signal containing therein a media access control address of the wireless LAN terminal to the new wireless LAN base station, and, when the network address contained in the synchronization confirmation signal does not coincide with the network address stored in the storage means, does not transmit an allocation request signal to the new wireless LAN base station, and each of the plurality of wireless LAN base stations comprising: means that transmits the beacon; means that, when the base station receives a synchronization request signal from a wireless LAN terminal having received the beacon, transmits to the wireless LAN terminal a synchronization confirmation signal containing therein the network address to which the wireless LAN base station is allocated; means that, when the base station receives that allocation request signal containing therein a media access control of the wireless LAN terminal which has been transmitted on from the wireless LAN terminal as a response to the synchronization confirmation signal, registers the media access control with that base station itself; and means that, when the base station receives the allocation request signal, transmits an allocation approval signal to the wireless LAN terminal.

According to a fourth aspect of the present invention, there is provided a wireless LAN hand-off method in a wireless LAN system including a wireless LAN terminal and a plurality of wireless LAN base stations, comprising: a step that the wireless LAN terminal stores a network address to which a first wireless LAN base station kept in wireless connection with the terminal itself is allocated; a step that the wireless LAN terminal, when the terminal has moved to outside a cell of the first wireless LAN base station, sequentially changes the channel for a carrier; a step that a second wireless LAN base station transmits a beacon; a step that the wireless LAN terminal, when the terminal receives the beacon from the second wireless LAN base station via a new channel, transmits a synchronization request signal to the second wireless LAN base station; a step that the second wireless LAN base station, when receiving a synchronization request signal from the wireless LAN terminal having received the beacon, transmits to the wireless LAN terminal a synchronization confirmation signal containing therein a network address to which the second wireless LAN base station is allocated; a step that the wireless LAN terminal receives a synchronization confirmation signal containing therein a network address, which is transmitted on from the second wireless base station in response to the synchronization request signal; a step that the wireless LAN terminal compares the network address contained in the synchronization confirmation signal with the network address stored in the storage means; a step that the wireless LAN terminal, when the network address contained in the synchronization confirmation signal coincides with the network address stored in the storage means, transmits an allocation request signal containing therein a media access control address of the wireless LAN terminal to the second wireless LAN base station, and, when the network address contained in the synchronization confirmation signal does not coincide with the network address stored in the storage means, does not transmit an allocation request signal to the second wireless LAN base station; a step that the second wireless LAN base station, when the base station receives that allocation request signal containing therein a media access control of the wireless LAN terminal which has been transmitted on from the wireless LAN terminal as a response to the synchronization confirmation signal, registers the media access control with that second wireless base station itself; and a step that the second wireless LAN base station, when the base station receives the allocation request signal, transmits an allocation approval signal to the wireless LAN terminal.

The network address may be the one that is defined in the Internet protocol.

### BRIEF DESCRIPTION OF THE DRAWINGS

FIG. 1 is a block diagram illustrating a construction of a wireless LAN base station according to an embodiment of the present invention;

FIG. 2 is a block diagram illustrating a construction of a wireless LAN terminal according to an embodiment of the present invention;

FIG. 3 is a view illustrating a construction of networks to which the present invention is applied; and

FIG. 4 is a sequence diagram illustrating the operations of the wireless LAN terminal and wireless LAN base station according to the embodiment of the present invention.

### DETAILED DESCRIPTION OF THE PREFERRED EMBODIMENTS

An embodiment of the present invention will now be explained. The system that, in a wireless LAN (Local Area Network) apparatus, enables a wireless LAN terminal to automatically select a wireless LAN base station is constructed in the way of, especially when the wireless LAN terminal moves in the neighborhood of a different network, causing the terminal to be allocated to the wireless LAN base station on the same network.

It is arranged that, when a wireless LAN terminal kept in communication with a wireless LAN base station moves from one wireless cell to another and has come into a state of its being able to communicate with a plurality of wireless LAN base stations, the terminal can automatically select the wireless LAN base station connected to the same network as before and continue to make its communication therewith.

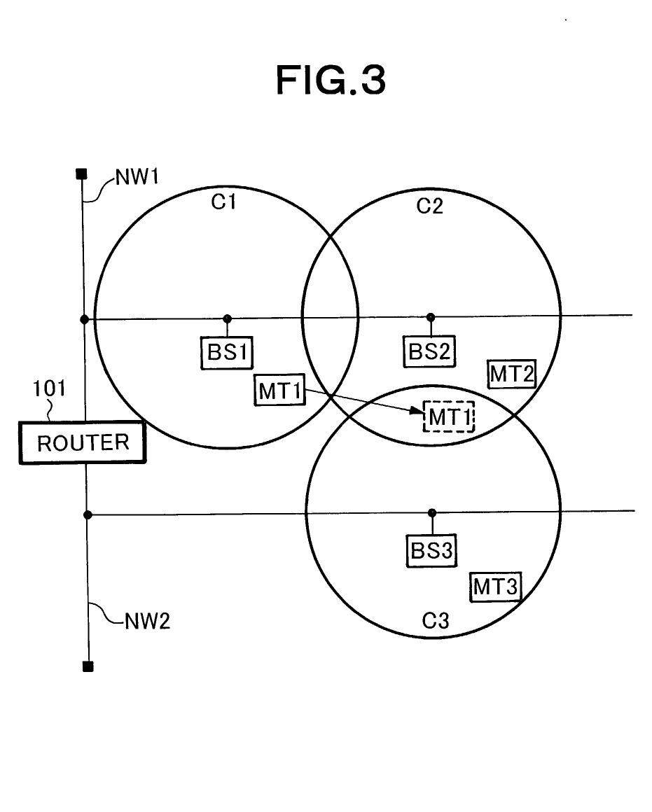

In FIG. 3, there is typically illustrated an example of a wireless LAN system construction to which the present invention is applied.

Referring to FIG. 3, a network NW1 and a network NW2 are connected to each other via a router 101. To the network NW1 there are connected wireless LAN base stations BS (base stations) 1 and BS2, and, to the network NW2, there is connected a wireless LAN base station BS3. Within a wireless cell C1 of the wireless LAN base station BS1, there exists a wireless LAN terminal (mobile terminal) MT1, within a wireless cell C2 of the wireless LAN base station BS2 there exists a wireless LAN terminal C2, and, within a wireless cell C3 of the wireless LAN base station B3 there exists a wireless LAN terminal C3. The wireless LAN terminals MT1, MT2, and MT3 perform their communications between them via wireless LAN base stations BS1, BS2, and BS3 in accordance with an IP (the Internet Protocol).

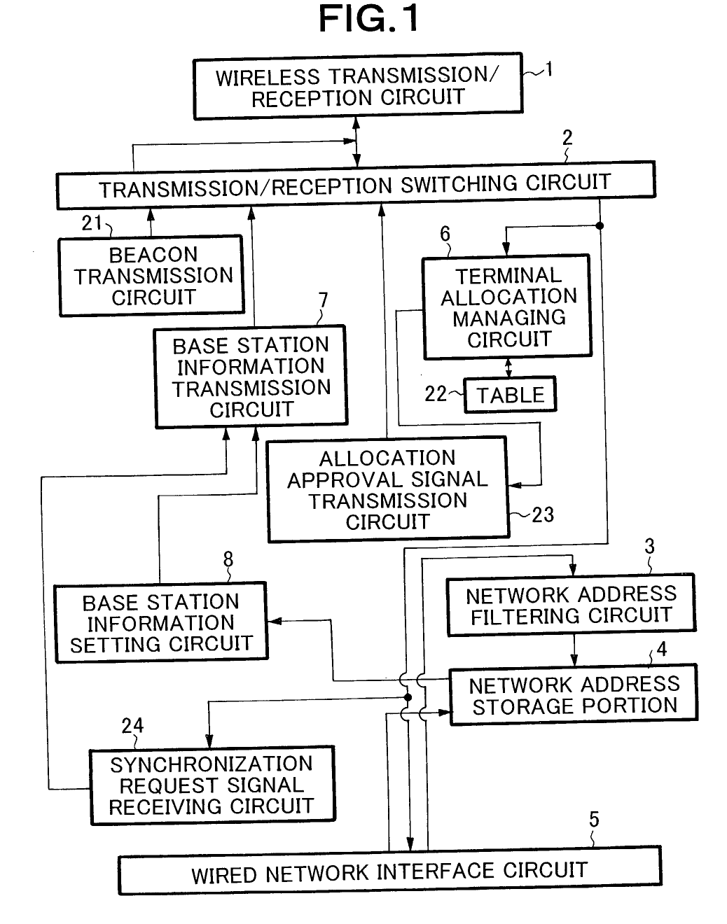

Referring to FIG. 1, each of the wireless LAN base stations BS1, BS2, and BS3 includes a wireless transmission/reception circuit 1, a transmission/reception switching circuit 2, a network filtering circuit 3, a network address storage portion 4, a wire network interface circuit 5, a terminal allocation management circuit 6, a table 22, a wireless LAN base station information transmission circuit 7, a wireless LAN base station information setting circuit 8, a beacon transmission circuit 21, a synchronization request signal reception circuit 24, and an allocation approval signal transmission circuit 23.

The wireless transmission/reception circuit 1 includes a modulation circuit, a demodulation circuit, etc. It supplies a transmission modulated signal to an antenna (not illustrated) and demodulates the received modulated signal it has received from the antenna. The transmission/reception switching circuit 2 performs switching between the transmission and the reception. The network address filtering circuit 3 extracts from data flowing on and through the wire network the network address of the network to which its own base station belongs, and stores this network address into the network address storage portion 4. It is to be noted that the network address means a network address in the IP address comprised of the network address and a host address. The network address storage portion 4 stores therein the network address extracted by the network address filtering circuit 3. The wire network interface circuit 5 is connected to a wire network cable (e.g. 10 BASE-T, 100BASE-T, etc.) for use on the Ethernet and the like. It receives a packet addressed to its own base station and transmits a packet that is destined for the network. The terminal allocation management circuit 6 registers with table 22 a MAC address of the wireless LAN terminal contained in the allocation request signal that has been received from this wireless LAN terminal intended to be allocated to its own base station. The table 22 holds therein the MAC addresses of all the wireless LAN terminals allocated in its own base station. The wireless LAN base station information setting circuit 8 produces wireless LAN base station information that contains therein the network address, held in the network address storage portion 4, of the network to which its own base station belongs. The wireless LAN base station information transmission circuit 7 transmits a synchronization confirmation signal containing therein the wireless LAN base station information to the wireless LAN terminal that has transmitted a synchronization request signal on to its own base station. The beacon transmission circuit 21 transmits a beacon to each of all the wireless LAN terminals situated with the cell of its own base station. The synchronization request signal reception circuit 24 receives from the wireless LAN terminal that has come into within the cell of its own base station and that has then transmitted a synchronization request signal on to the beacon, this synchronization request signal of that wireless LAN terminal. The allocation approval signal transmission circuit 23 transmits an allocation approval signal to the wireless LAN terminal that has transmitted an allocation request signal over to its own base station.

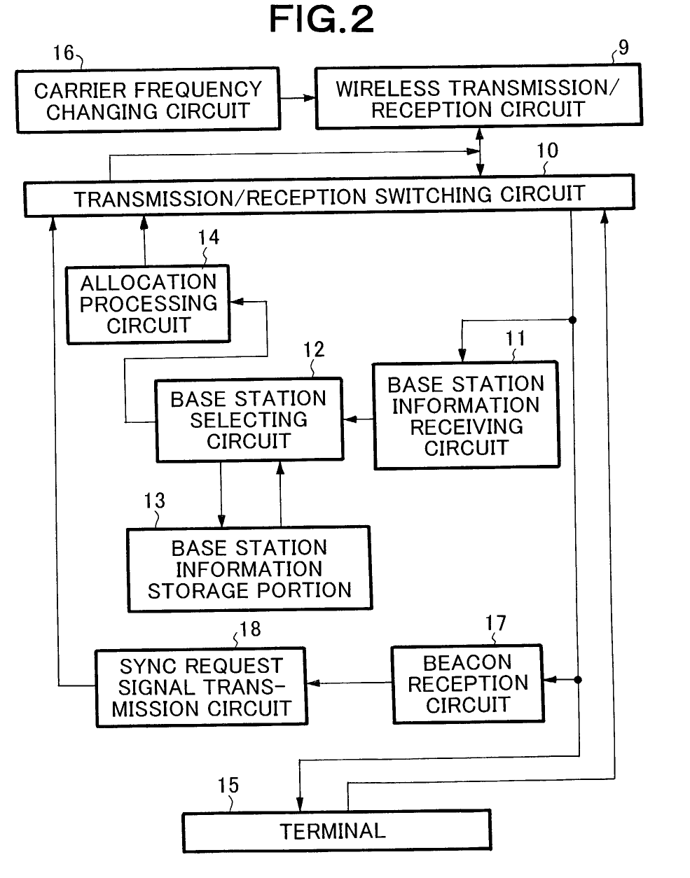

Referring to FIG. 2, each of the wireless LAN terminals MT1, MT2, and MT3 includes a wireless transmission/reception circuit 9, a transmission/reception switching circuit 10, a wireless LAN base station information reception circuit 11, a wireless LAN base station selection circuit 12, a wireless LAN base station information storage portion 13, an allocation-processing circuit 14, a terminal 15, a carrier frequency changing circuit 16, a beacon reception circuit 17, and a synchronization request signal transmission circuit 18.

The wireless transmission/reception circuit 9 includes a modulation circuit, a demodulation circuit, etc. It supplies a transmission modulated signal to an antenna (not illustrated) and demodulates the received modulated signal it has received from the antenna. The transmission/reception switching circuit 10 performs switching between the transmission and the reception. The wireless LAN base station information reception circuit 11 receives a synchronization confirmation signal (including a wireless LAN base station information) that has been transmitted on from the wireless LAN base station. The synchronization confirmation signal is transmitted on from the wireless LAN base station to which the terminal transmitted a synchronization request signal as later described. The wireless LAN base station information storage portion 13 holds the wireless LAN base station information of the wireless LAN base station to which the terminal belonged so far, until the communication between the terminal and a new wireless LAN base station is established. When that communication has been established, the storage portion 13 replaces the wireless LAN base station information it held theretofore, with that wireless LAN base station information of the new wireless LAN base station. The wireless LAN base station selection circuit 12 compares the network address contained in the wireless LAN base station information contained in its received synchronization confirmation signal with the network address contained in the wireless LAN base station information stored in the wireless LAN base station information storage portion 13. If the both have coincide with each other, this selection circuit 12 selects this wireless LAN base station. The allocation-processing circuit 14 transmits an allocation request signal containing therein the terminal information to the selected wireless LAN base station via the wireless portion transmission/reception circuit 9. The terminal 15 is, for example, a portable information terminal such as a lap-top computer, a PDA (personal digital assistant), and has an IP address and a MAC (media access control) address. The carrier frequency changing circuit 16 changes the frequency of the communication channel between its own wireless LAN terminal and the wireless LAN base station. The beacon reception circuit 17 receives a beacon that is transmitted on from the wireless LAN base station. The synchronization request signal transmission circuit 18 transmits a synchronization request signal to the wireless LAN base station when the beacon reception circuit 17 has received a beacon.

In this embodiment, the network address filtering circuit 3, terminal allocation management circuit 6, wireless LAN base station information transmission circuit 7, and wireless LAN base station information setting circuit 8 may be arranged so that their functions are realized by a control program that is executed on a computer within the wireless LAN base station. The wireless LAN base station information reception circuit 11, wireless LAN base station selection circuit 12, and allocation-processing circuit 14 may be arranged so that their functions are realized by a control program that is executed on a computer within the wireless LAN terminal.

For example, as illustrated in FIG. 3, assume that the wireless LAN terminal MT1 has moved from within a wireless cell C1 formed by a wireless LAN base station BS1 of a network NW1 into an overlapped area between wireless cells C2 and C3 formed respectively by wireless LAN base stations BS2 and BS3. Then, the wireless LAN base stations BS2 and BS3 each transmit to the wireless LAN terminal MT1 a synchronization confirmation signal containing therein the wireless LAN base station information of the wireless LAN base station, in response to a synchronization request signal it has received from the wireless LAN terminal MT1.

The wireless LAN terminal MT1 compares each of the network addresses contained in the received wireless LAN base station information of the two wireless LAN base stations BS2 and BS3 with the network address of the wireless LAN base station, having had the terminal MT1 allocated therein immediately before the movement thereof, that is stored in the wireless LAN base station information storage portion 13 of the wireless LAN terminal MT1. Therefore, the terminal MT1 transmits an allocation request signal to the wireless LAN base station that transmitted the network address that coincided with the previous network address stored in that terminal MT1.

As a result of this, it is possible to cause the terminal MT1 to be newly allocated to the wireless LAN base station that has the network address the same as that of the wireless LAN base station before its movement. Accordingly, there is no need to change the setting in the wireless LAN terminal (the need to change the network address). In addition, there is also the effect that the communication is not disconnected.

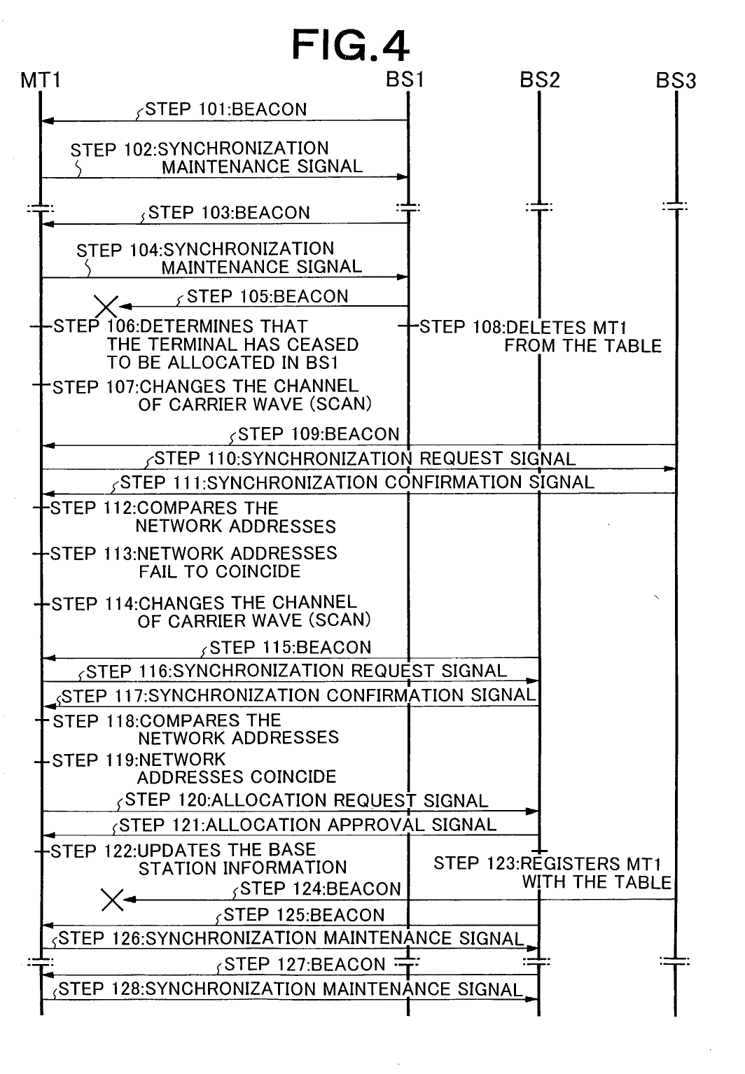

The operation of this embodiment will be explained. First, the operation of the wireless LAN base station apparatus will be explained with reference to FIG. 4.

During a time period in which the wireless LAN terminal MT1 is kept staying within the cell of the wireless LAN base station BS1, there is repeated the operation of causing the wireless LAN terminal MT1 to receive the beacon transmitted from the wireless LAN base station BS1 and causing the MT1 to transmit a synchronization maintenance signal to the wireless LAN base station BS1 (step S101 to S104).

When the wireless LAN terminal MT1 moves to outside the cell of the wireless LAN base station BS1, the beacon the wireless LAN base station BS1 has transmitted ceases to reach the wireless LAN terminal MT1 (step S105) and the wireless LAN terminal MT1 comes to stop transmitting a synchronization maintenance signal to the wireless LAN base station BS1. Therefore, the wireless LAN base station BS1 determines that the wireless LAN terminal MT1 has ceased to exist within its own cell, and deletes the wireless LAN terminal MT1 from its table 22 (step S108).

On the other hand, since the wireless LAN terminal MT1 has stopped receiving the beacon from the wireless LAN base station BS1, it determines that it has stopped being allocated in the wireless LAN base station BS1 (step S106), and changes the carrier channel in order to scan other wireless LAN base stations (step S107).

Assume that the wireless LAN terminal MT1 enters the overlap area between the cell of the wireless LAN base station BS2 and the cell of the wireless LAN base station BS3 and has initially received a beacon from the wireless LAN base station BS3 (step S109). Then, the wireless LAN terminal MT1 transmits a synchronization request signal to the wireless LAN base station BS3 (step S110) and, in reply to this, the wireless LAN base station BS3 transmits to the wireless LAN terminal MT1 a synchronization confirmation signal containing therein the wireless LAN base station information (including the network address and the MAC address) (step S111).

The wireless LAN terminal MT1 compares the network address contained in its received synchronization confirmation signal with the network address held in the wireless LAN base station information storage portion 13 (step S112). The network address contained in the received synchronization signal is the one of the wireless LAN base station BS3 while the network address held in the wireless LAN base station information storage portion 13 is the one of the wireless LAN base station BS1. However, since the network to which the wireless LAN base station BS1 belongs is different from the one to which the wireless LAN base station BS3 belongs, the network addresses of the both are different from each other. Accordingly, the wireless LAN terminal MT1 determines that the compared network addresses are out of coincidence (step S113) and then further changes the carrier channel in order to seek for the wireless LAN base station having the network address the same as that held in the wireless LAN base station information storage portion 13 (step S114).

Next, assume that the wireless LAN terminal MT1 has received a beacon from the wireless LAN base station BS2 (step S115). The wireless LAN terminal MT1 transmits a synchronization request signal to the wireless LAN base station BS2 (step S116). In reply to this, the wireless LAN base station BS2 transmits to the wireless LAN terminal MT1 a synchronization confirmation signal containing therein the wireless LAN base station information (including the network address and MAC address) (step S117).

The wireless LAN terminal MT1 compares the network address contained in its received synchronization confirmation signal and the network address held in the wireless LAN base station information storage portion 13 (step S118). The network address contained in the received synchronization signal is the one of the wireless LAN base station BS2 while the network address held in the wireless LAN base station information storage portion 13 is the one of the wireless LAN base station BS1. However, since the network to which the wireless LAN base station BS1 belongs is the same as the one to which the wireless LAN base station BS2 belongs, the network addresses of the both are in coincidence. Accordingly, the wireless LAN terminal MT1 determines that the compared network addresses have coincided with each other (step S119) and then transmits an allocation request signal containing therein the MAC address of the wireless LAN terminal MT1 to the wireless LAN base station BS2 (step S120).

The wireless LAN base station BS2 transmits an allocation approval signal to the wireless LAN terminal MT1 (step S121) and then registers with its table 22 the MAC address contained in its received allocation request signal (step S123).

The wireless LAN terminal MT1 updates the base station information stored in its base station information storage portion 13 with the base station information contained in the synchronization confirmation signal it received in step S117 (step S122). Incidentally, since the network address has not been changed, the MAC is only updated.

Thereafter, even when the wireless LAN base station BS3 transmits a beacon to the mobile station MT1 existing within a distance enabling the beacon to reach that station MT1, because the carrier channel of the mobile station MT1 and the carrier channel of the wireless LAN base station BS3 differ from each other, this mobile station MT1 does not receive that beacon (step S124).

On the other hand, since the carrier channel of the mobile station MT1 and the carrier channel of the wireless LAN base station BS2 coincide with each other, there is repeated the operation of allowing the wireless LAN terminal MT1 to receive the beacon the wireless LAN base station BS2 has transmitted and allowing that terminal MT1 to transmit a synchronization maintenance signal to the wireless LAN base station BS2 (steps S125 to S128).

According to this embodiment, as illustrated in FIG. 3, in a case where the wireless LAN terminal MT1 that was allocated to the wireless LAN base station apparatus BS1 connected to one network NW1 has moved to the overlap area formed by a plurality of wireless LAN base stations BS2 and BS3, the wireless LAN terminal MT1 automically selects the wireless LAN base station apparatus BS2 with regard to that no change of the network is necessary and can then perform allocation-processing.

On the other hand, in a case where not adopting the construction of the present invention, when the wireless LAN terminal MT1 that was allocated to the wireless LAN base station apparatus BS1 connected to one network NW1 has moved to the overlap area formed by a plurality of wireless LAN base stations BS2 and BS3, it is also possible that the wireless LAN terminal MT1 may select the wireless LAN base station BS3 and, at this time, change of the network becomes necessary. Further, when the wireless LAN terminal MT1 moves to within the cell of the wireless LAN base station BS2 by slightly moving, change of the network again becomes necessary. Resultantly, the communication also stops being made.

In contrast to this, according to the present invention, the mobile terminal can be automically allocated, with a simple construction, to the wireless LAN base station having the same network address that it had had before it moved. Therefore, advantageously, it is possible to avoid changing the setting of the wireless LAN terminal and therefore to prevent the communication from being interrupted.

What is claimed is:

1. A wireless LAN terminal comprising:
storage means that stores a network address to which a fist wireless LAN base station kept in wireless connection with the terminal itself is allocated;
means that, when the terminal has moved to outside a cell of the first wireless LAN base station, sequentially changes the channel for a carrier;
means that, when the terminal receives a beacon from a new wireless LAN base station via a new channel, transmits a synchronization request signal to the new wireless LAN base station;
means that receives a synchronization confirmation signal containing therein a network address, which is sent on from the new wireless base station in response to the synchronization request signal;
means that compares the network address contained in the synchronization confirmation signal with the network address stored in the storage means; and
means that, when the network address contained in the synchronization confirmation signal coincides with the network address stored in the storage means, transmits an allocation request signal containing therein a media access control address of the wireless LAN terminal to the new wireless LAN base station, and, when the network address contained in the synchronization confirmation signal does not coincide with the network address stored in the storage means, does not transmit an allocation request signal to the new wireless LAN base station.

2. A wireless LAN terminal according to claim 1, wherein the network address is the one that is defined in the Internet protocol.

3. A wireless LAN base station comprising:
means that transmits a beacon;
means that, when the base station receives a synchronization request signal from a wireless LAN terminal having received the beacon, transmits to the wireless LAN terminal a synchronization confirmation signal containing therein the network address to which the wireless LAN base station is allocated;
means that, when the base station receives that allocation request signal containing therein a media access control of the wireless LAN terminal which has been transmitted on from the wireless LAN terminal as a response to the synchronization confirmation signal, registers the media access control with that base station itself; and
means that, when the base station receives the allocation request signal, transmits an allocation approval signal to the wireless LAN terminal.

4. A wireless LAN base station according to claim 3, wherein the network address is the one that is defined in the Internet protocol.

5. A wireless LAN system, the wireless LAN system including a wireless LAN terminal and a plurality of wireless LAN base stations, the wireless LAN terminal comprising:
storage means that stores a network address to which a fist wireless LAN base station kept in wireless connection with the terminal itself is allocated;
means that, when the terminal has moved to outside a cell of the first wireless LAN base station, sequentially changes the channel for a carrier;
means that, when the terminal receives a beacon from a new wireless LAN base station via a new channel, transmits a synchronization request signal to the new wireless LAN base station;
means that receives a synchronization confirmation signal containing therein a network address, which is transmitted on from the new wireless base station in response to the synchronization request signal;
means that compares the network address contained in the synchronization confirmation signal with the network address stored in the storage means; and
means that, when the network address contained in the synchronization confirmation signal coincides with the network address stored in the storage means, transmits an allocation request signal containing therein a media access control address of the wireless LAN terminal to the new wireless LAN base station, and, when the network address contained in the synchronization confirmation signal does not coincide with the network address stored in the storage means, does not transmit an allocation request signal to the new wireless LAN base station, and
each of the plurality of wireless LAN base stations comprising:
means that transmits the beacon;
means that, when the base station receives a synchronization request signal from a wireless LAN terminal having received the beacon, transmits to the wireless LAN terminal a synchronization confirmation signal containing therein the network address to which the wireless LAN base station is allocated;
means that, when the base station receives that allocation request signal containing therein a media access control of the wireless LAN terminal which has been transmitted on from the wireless LAN terminal as a response to the synchronization confirmation signal, registers the media access control with that base station itself; and
means that, when the base station receives the allocation request signal, transmits an allocation approval signal to the wireless LAN terminal.

6. A wireless LAN system according to claim 5, wherein the network address is the one that is defined in the Internet protocol.

7. A wireless LAN hand-off method in a wireless LAN system including a wireless LAN terminal and a plurality of wireless LAN base stations, comprising:
a step that the wireless LAN terminal stores a network address to which a first wireless LAN base station kept in wireless connection with the terminal itself is allocated;
a step that the wireless LAN terminal, when the terminal has moved to outside a cell of the first wireless LAN base station, sequentially changes the channel for a carrier;
a step that a second wireless LAN base station transmits a beacon;
a step that the wireless LAN terminal, when the terminal receives the beacon from the second wireless LAN base station via a new channel, transmits a synchronization request signal to the second wireless LAN base station;
a step that the second wireless LAN base station, when receiving a synchronization request signal from the wireless LAN terminal having received the beacon, transmits to the wireless LAN terminal a synchronization confirmation signal containing therein a network address to which the second wireless LAN base station is allocated;
a step that the wireless LAN terminal receives a synchronization confirmation signal containing therein a network address, which is transmitted on from the second wireless base station in response to the synchronization request signal;
a step that the wireless LAN terminal compares the network address contained in the synchronization confirmation signal with the network address stored in the storage means;
a step that the wireless LAN terminal, when the network address contained in the synchronization confirmation signal coincides with the network address stored in the storage means, transmits an allocation request signal containing therein a media access control address of the wireless LAN terminal to the second wireless LAN base station, and, when the network address contained in the synchronization confirmation signal does not coincide with the network address stored in the storage means, does not transmit an allocation request signal to the second wireless LAN base station;
a step that the second wireless LAN base station, when the base station receives that allocation request signal containing therein a media access control of the wireless LAN terminal which has been transmitted on from the wireless LAN terminal as a response to the synchronization confirmation signal, registers the media access control with that second wireless base station itself; and
a step that the second wireless LAN base station, when the base station receives the allocation request signal, transmits an allocation approval signal to the wireless LAN terminal.

8. A wireless LAN hand-off method according to claim 7, wherein the network address is the one that is defined in the Internet protocol.
